(19) United States
(12) Patent Application Publication
(10) Pub. No.: US 2025/0013742 A1
(43) Pub. Date: Jan. 9, 2025

(54) SYSTEMS, METHODS, AND APPARATUSES FOR DETECTING CYBERSECURITY EVENTS USING CENTRALIZED DATA AGGREGATION AND DYNAMIC CONSTRAINT SPECIFICATION TEMPLATES IN AN ELECTRONIC ENVIRONMENT

(71) Applicant: BANK OF AMERICA CORPORATION, Charlotte, NC (US)

(72) Inventors: Tomas M. Castrejon, III, Fort Mill, SC (US); James J. Siekman, Charlotte, NC (US); David Nardoni, Sierra Madre, CA (US)

(73) Assignee: BANK OF AMERICA CORPORATION, Charlotte, NC (US)

(21) Appl. No.: 18/219,298

(22) Filed: Jul. 7, 2023

(51) Int. Cl. G06F 21/55

(52) U.S. Cl. CPC G06F 21/554; G06F 2221/034

(57) ABSTRACT

Systems, computer program products, and methods are described herein for detecting cybersecurity events using centralized data aggregation and dynamic constraint specification templates in an electronic environment. The present disclosure is configured to identify at least one of a malfeasant event or a potential malfeasant event; parse the data of the malfeasant event or the potential malfeasant event; generate a primary dynamic constraint specification template comprising a base set of parameters; identify at least one secondary malfeasant event or at least one secondary potential malfeasant event; parse the secondary data of the least one secondary malfeasant event or the at least one secondary potential malfeasant event; and generate at least one secondary dynamic constraint specification template comprising a secondary set of parameters, wherein the at least one secondary dynamic constraint specification template is a modification of the primary dynamic constraint specification template.

### TECHNOLOGICAL FIELD

Example embodiments of the present disclosure relate to systems and methods for machine interpretation of security data. Specifically, the example embodiments of the present disclosure relate to detecting cybersecurity events using centralized data aggregation and dynamic constraint specification templates in an electronic environment.

### BACKGROUND

In a large computing environment with numerous interconnected end-point systems, it is crucial to gather diverse information, including system events, malware type events, and component malfunction events, to ensure comprehensive monitoring and timely detection of potentially unauthorized access, system errors, or data loss events.

Applicant has identified a number of deficiencies and problems associated with timely detection of potentially unauthorized access, system errors, or data loss events. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for to detecting cybersecurity events using centralized data aggregation and dynamic constraint specification templates in an electronic environment.

To facilitate the process of more efficient and effective detection of potentially unauthorized access, system errors, or data loss events within large computing environments, the present disclosure offers various systems and methods for employing data aggregators such as Security Information and Event Management (SIEM) systems, which collect, normalize, and correlate data from various sources, providing a centralized platform for security monitoring and analysis. By integrating Artificial Intelligence (AI) and Machine Learning (ML) techniques into the SIEM system, the present invention enhances entity ability to process large volumes of aggregated data, efficiently identifying patterns that could be indicative of potential threats, issues or anomalies.

While AI/ML techniques have proven effective in identifying patterns within large datasets, they often require external input to determine the significance of the identified patterns. Human expertise and domain-specific knowledge remain essential in interpreting the results generated by AI/ML models, discerning whether the detected patterns indicate potential threats, or anomalies. This collaboration between AI/ML systems and human analysts ensures a more comprehensive and accurate understanding of the computing environment's security landscape. By combining the strengths of AI/ML's processing capabilities with human intuition and contextual understanding, entities can employ the present invention to enhance overall security posture, allowing for more informed decisions and more effective response to potential issues and system vulnerabilities.

Additionally, and as shown and described below the above systems, methods and apparatuses may comprise the following features in order to detect cybersecurity events using centralized data aggregation and dynamic constraint specification templates in an electronic environment.

In one aspect, a system for detecting cybersecurity events using centralized data aggregation and dynamic constraint specification templates in an electronic environment is provided. In some embodiments, the system may comprise: a memory device with computer-readable program code stored thereon; at least one processing device, wherein executing the computer-readable code is configured to cause the at least one processing device to perform the following operations: identify at least one of a malfeasant event or a potential malfeasant event, wherein the malfeasant event or the potential malfeasant event comprises data; parse the data of the malfeasant event or the potential malfeasant event; generate a primary dynamic constraint specification template comprising a base set of parameters, wherein the base set of parameters are based on the parsed data of the malfeasant event or the potential malfeasant event; identify at least one secondary malfeasant event or at least one secondary potential malfeasant event, wherein the at least one secondary malfeasant event or the at least one secondary potential malfeasant event comprises secondary data; parse the secondary data of the least one secondary malfeasant event or the at least one secondary potential malfeasant event; and generate at least one secondary dynamic constraint specification template comprising a secondary set of parameters, wherein the secondary set of parameters are based on the parsed secondary data, and wherein the at least one secondary dynamic constraint specification template is a modification of the primary dynamic constraint specification template.

In some embodiments, the system may further comprise automatically storing the primary dynamic constraint specification template in a long term data storage.

In some embodiments, the system may further comprise apply a machine learning (ML) model to at least one of the primary dynamic constraint specification template or the at least one secondary dynamic constraint specification template; and determine, by the ML model, at least one primary pattern of the data of the primary dynamic constraint specification template and at least one secondary pattern of the secondary data of the at least one secondary dynamic constraint specification template.

In some embodiments, the system may further comprise generating, by an artificial intelligence (AI) engine, at least one vulnerability vector based on the primary dynamic constraint specification template and the at least one primary pattern determined by the ML model; generating, by the AI engine, at least one secondary vulnerability vector based on at least one secondary dynamic constraint specification template and the at least one secondary pattern determined by the ML model; and comparing, by the AI engine, the at least one primary vulnerability vector and the at least one secondary vulnerability vector; and identifying at least one change between the at least one primary vulnerability vector and the at least one secondary vulnerability vector. In some embodiments, the system may further comprise generating, based on the at least one change, a vulnerability vector change interface component, wherein the vulnerability vector change interface component comprises an indication of the at least one change between the at least one primary vulnerability vector and the at least one secondary vulnerability vector, and wherein the vulnerability vector change interface component is generated immediately after the at least one change is identified; and transmitting the vulnerability vector change interface component to a user device associated with an entity associated with the at least one of the malfeasant event, the potential malfeasant event, the at least one secondary malfeasant event, or the at least one secondary potential malfeasant event, wherein the vulnerability vector change interface component is configured to configure a graphical user interface (GUI) of the user device.

In some embodiments, the system may further comprise: identifying a most recent malfeasant event or a most recent potential malfeasant event, wherein the most recent malfeasant event or the most recent potential malfeasant event comprises most recent data; parsing the most recent data; generating a most recent dynamic constraint specification template comprising a most recent set of parameters, wherein the most recent set of parameters are based on the parsed most recent data, and wherein the most recent dynamic constraint specification template is a modification of the primary dynamic constraint specification template; applying the ML model to the most recent dynamic constraint specification template; determining, by the ML model, at least one most recent pattern based on the most recent dynamic constraint specification template; comparing the most recent pattern to the at least one secondary pattern; and determining whether at least one change is present between the most recent pattern and the at least one secondary pattern, wherein, in an instance where at least one change is present, phasing out the at least one secondary dynamic constraint specification template. In some embodiments, the at least one secondary dynamic constraint specification template is generated at time previous to the most recent dynamic constraint specification template and at a time after to the primary dynamic constraint specification template.

In some embodiments, the primary dynamic constraint specification template and the at least one secondary dynamic specification template comprise at least one rule for the primary set of parameters or for the secondary set of parameters.

In some embodiments, the primary set of parameters and the at least one secondary set of parameters comprise telemetry data.

In some embodiments, the data of at least one malfeasant event, the at least one potential malfeasant event, the at least one secondary malfeasant event, or at least one secondary potential malfeasant event comprise at least one of an indicator of compromise (IoC) data, account access data, authentication credential data, geographic data, transaction data, or transaction party data.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for detecting cybersecurity events using centralized data aggregation and dynamic constraint specification templates in an electronic environment, in accordance with an embodiment of the disclosure;

FIG. 2 illustrates an exemplary machine learning (ML) subsystem architecture 200, in accordance with an embodiment of the invention;

FIG. 3 illustrates a process flow for detecting cybersecurity events using centralized data aggregation and dynamic constraint specification templates in an electronic environment, in accordance with an embodiment of the disclosure;

FIG. 4 illustrates a process flow for identifying at least one change between the primary vulnerability vector and the at least one secondary vulnerability vector, in accordance with an embodiment of the disclosure;

FIG. 5 illustrates a process flow for transmitting a vulnerability vector change interface component to a user device for configuration on graphical user interface (GUI), in accordance with an embodiment of the disclosure; and

FIG. 6 illustrates a process flow for determining whether at least one change is present between a most recent pattern and at least one secondary pattern.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data. An “entity” can encompass a wide range of organizations, such as institutions, groups, associations, financial institutions, establishments, companies, unions, authorities, and similar entities. The common factor among these entities is their utilization of information technology resources for processing substantial amounts of data. As such, an “entity” in this context denotes any organization or institution that employs information technology resources capable of processing large volumes of data, which can pertain to different aspects of the entity's operations.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device. Additionally, as used herein, a “resource” may also encompass computing or network resources. This broader definition of a resource includes elements such as computational power, storage capacity, network bandwidth, software applications, databases, virtual machines, servers, routers, switches, and other similar components associated with computing or network infrastructure.

As used herein, a “template” (e.g., such as that used within the “dynamic constraint specification template” or “dynamic constraint specification matrix template”) refers to a pre-formatted, customizable document or tool that provides a structured approach to identifying, evaluating, and addressing security threats. A security assessment template typically consists of a set of predefined sections, fields, or criteria that guide users through the process of conducting a comprehensive security or threat assessment. In some embodiments, each section of the template corresponds to a specific aspect or step of the assessment process. In some embodiments, a section includes fields for documenting the information or system components that the assessment covers. This may include hardware, software, data, networks, and human resources. In some embodiments, a section may include a list of users or document potential threats to each user. Threats could be anything that could utilize a vulnerability to cause harm to the system. In some embodiments, a section may include identifying data and documentation for potential vulnerabilities that threats could utilize. Vulnerabilities could range from weak passwords and out-of-date software to inadequate security policies or data storage methods. In some embodiments, a section may include fields for evaluating and rating the possibility or likelihood associated with each threat and vulnerability combination. In some embodiments, this involves considering the potential impact of the threat or vulnerability and the likelihood of it occurring. In some embodiments, a section may include documented strategies for mitigating each threat. This could include a range of actions from patching software vulnerabilities and improving security policies to investing in new security technologies. In some embodiments, a section may include an area to note when the assessment was conducted, who conducted it, and when it will be reviewed and updated next. In some embodiments, a section may include a starting point and can be customized according to the specific needs and context of an organization. By following a structured approach, security assessment templates help ensure that all relevant factors are considered, which leads to more accurate assessments and more effective mitigation strategies.

As used herein, an “artificial intelligence” (AI) system is a computing framework designed to perform tasks that normally require human intelligence, such as understanding natural language, recognizing patterns, problem-solving, and making decisions. It is understood that these systems operate by mimicking the neural networks of humans in a simplified form. In some embodiments, they may consist of interconnected layers of nodes, often referred to as artificial neurons, that process information using dynamic state responses to external inputs. They are trained by feeding them large volumes of data and adjusting the connections between the nodes using complex mathematical algorithms based on the principles of statistics and calculus, allowing them to learn from this data. In some embodiments, an AI system may be stored and executed in various ways depending on the requirements of the specific implementation. It is understood that AI systems can be hosted on local machines, in data centers, or in the cloud. It is further understood that cloud-based AI systems are becoming increasingly common due to their scalability, cost-effectiveness, and the ability to handle vast amounts of data. AI systems may be employed for identifying data patterns and vulnerability vectors due to their ability to analyze large and complex datasets rapidly and accurately.

As used herein “machine learning” (ML), a subset of AI, may be utilized in some embodiments. ML algorithms learn from the data they process, enabling them to discover hidden insights and patterns that may not be apparent to human analysts. For instance, in cybersecurity, AI systems can analyze network traffic to identify patterns consistent with cyber threats or vulnerabilities, providing an effective tool for proactively safeguarding systems and data. It is understood that there are several types of ML algorithms, each suited to different types of tasks. These include supervised learning where the algorithm learns from labeled training data, and then applies what it has learned to new data. In further embodiments, unsupervised learning may employ unlabeled data and learn by identifying patterns and structures within it. Additionally, in some embodiments, reinforcement learning may involve an algorithm that learns by interacting with its environment and receives rewards or demerits based on its actions. Furthermore, semi-supervised learning may include a blend of supervised and unsupervised learning wherein the invention employs the use of an algorithm which learns from a small amount of labeled data supplemented by a large amount of unlabeled data. Particularly regarding cybersecurity, ML may be used to identify patterns consistent with cyber vulnerabilities. The ML algorithm of the invention may analyze network traffic data, system logs, user behavior, or the like, and learn what “normal” activity looks like on an entity network infrastructure. Once the model has been trained on this data, it can then monitor network activity and identify anomalies or deviations from the normal pattern. These anomalies could potentially be cyber vulnerabilities, such as an intrusion, malicious activity, or use of a software vulnerability. This proactive approach to cybersecurity allows vulnerabilities to be detected and mitigated early, reducing the potential damage they may cause. In some embodiments, ML may provide valuable insights and automated decision-making capabilities across multiple entity communication channels.

In large computing environments with numerous interconnected end-point systems, it is crucial to gather diverse information, including system events, malware type events, and component malfunction events, to ensure comprehensive monitoring and timely detection of potentially unauthorized access, system errors, or data loss events. There are a number of deficiencies and problems associated with timely detection of potentially unauthorized access, system errors, or data loss events with respect to conventional solutions.

To facilitate the process of more efficient and effective detection of potentially unauthorized access, system errors, or data loss events within large computing environments, the present invention offers various systems and methods for employing data aggregators such as Security Information and Event Management (SIEM) systems, which collect, normalize, and correlate data from various sources, providing a centralized platform for security monitoring and analysis. By integrating Artificial Intelligence (AI) and Machine Learning (ML) techniques into the SIEM system, the present invention enhances entity ability to process large volumes of aggregated data, efficiently identifying patterns that could be indicative of potential issues or anomalies.

While AI/ML techniques have proven effective in identifying patterns within large datasets, they often require external input to determine the significance of the identified patterns. Human expertise and domain-specific knowledge remain essential in interpreting the results generated by AI/ML models, discerning whether the detected patterns indicate potential threats, or anomalies. This collaboration between AI/ML systems and human analysts ensures a more comprehensive and accurate understanding of the computing environment's security landscape. By combining the strengths of AI/ML's processing capabilities with human intuition and contextual understanding, entities can employ the present invention to enhance overall security posture, allowing for more informed decisions and more effective response to potential issues and system vulnerabilities.

Embodiments of the invention incorporate human expertise and domain-specific knowledge into a dynamic template with multiple parameters tailored to identify specific scenarios when a pattern is indicative of a system vulnerability. This dynamic template, referred to as a “Constraint Specification Matrix,” can adapt to evolving landscapes, allowing entities to refine and adjust the parameters (e.g., vulnerability vectors, or the like) based on real-world experiences and emerging trends. By continuously updating and optimizing the Constraint Specification Matrix, entities can ensure that the AI/ML-based systems remain relevant and effective in detecting vulnerabilities and protecting against known vulnerabilities. This collaborative approach, combining the strengths of human intuition with the processing capabilities of AI/ML, creates a more robust and agile security posture, empowering entities to respond proactively to the ever-changing cybersecurity landscape.

The Constraint Specification Matrix template is system agnostic and serves as tool for evaluating the likelihood of a vulnerability occurring within any computing environment depending on the type of data generated by the computing environment. By incorporating a diverse array of parameters sourced from domain-specific knowledge, industry best practices, and real-time data analysis, the template enables entities to assess potential vulnerabilities with greater precision and accuracy.

In some embodiments, the invention leverages a Constraint Specification Matrix template that can be designed with a base set of parameters that apply to the computing environment, as well as temporary versions tailored to address significant changes, such as change in vulnerability vectors, code patches, version updates, or infrastructure modifications to the computing environment. These temporary versions incorporate parameters specific to the changes, enabling the entity to closely monitor and assess any potential vulnerabilities arising from the updates. Over time, these temporary versions can be replaced automatically based on predefined constraints indicating that the updated components have stabilized and integrated well with the overall computing environment. This flexible and adaptive approach ensures that the template remains relevant and effective in addressing both persistent and transient vulnerabilities.

Furthermore, in some embodiments, the invention offers the ability to customize the dynamic Constraint Specification Matrix to include parameters specific to a computing environment, ensuring a bespoke approach to security monitoring and vulnerability detection. In the context of access management and authentication, the data aggregator (e.g., a Business Rules Engine (BRE), or the like) can aggregate data related to login attempts, user privileges, and other relevant events from the computing environment. For example, each of these data elements may be retrieved from a System of Record (SOR) published by the computing environment. By employing AI/ML techniques, patterns within this data can be identified, offering insights into potential vulnerabilities, such as unauthorized access or privilege escalation attempts. The template's parameters, fine-tuned for the unique characteristics of the computing environment, can then be used to determine whether a detected pattern (e.g., toxic combination of access privileges, or the like) is indicative of a genuine vulnerability or simply a benign activity. Furthermore, the Constraint Specification Matrix can include parameters related to behavioral patterns of access privilege assignments across the computing environment, offering insights into specific actions executed by users to provide other users (or themselves) access to resources within the computing environment that may indicate malfeasant action. This adaptive and context-aware approach enables entities to focus their security efforts more effectively, enhancing their ability to proactively detect and respond to potential vulnerabilities in a timely manner.

Additionally, embodiments of the invention may employ AI/ML to identify a likelihood of a case contributing to a loss based on a database of historical cases. By utilizing case data (e.g., date, geographic location, line of business, communication channel, or the like) from historical cases that are known to have caused a loss, AI/ML models can analyze historical patterns and trends to predict potential vulnerabilities. User input labeling known cases that resulted in a loss can help train the AI/ML models, enhancing their accuracy and effectiveness in identifying cases with a high percentage likelihood of vulnerability manifestation. The output generated by these models is a likelihood score that indicates the probability of a case contributing to a loss, enabling organizations to preempt the need for mitigation. By proactively addressing cases with high likelihood scores before they escalate into actual losses, entities can optimize their vulnerability management strategies, reduce financial exposure, and maintain a more secure and resilient operational environment.

In order to effectively initiate remedial actions based on the likelihood of a case contributing to a loss, a threshold can be assigned to serve as a decision-making criterion. This threshold value represents a specific level of likelihood that the entity deems significant enough to warrant intervention. By comparing the likelihood scores generated by the AI/ML models against the predefined threshold, organizations can determine whether a case's likelihood level necessitates immediate remedial action. This approach ensures that resources are allocated efficiently and that remedial actions are focused on cases that pose the greatest vulnerability to the entity's financial stability and operational integrity. Additionally, the threshold value can be fine-tuned over time based on changing landscapes and entity priorities, enabling a more agile and adaptive vulnerability management strategy.

Accordingly, the present disclosure acts to identify at least one of a malfeasant event or a potential malfeasant event, wherein the malfeasant event or the potential malfeasant event comprises data; parse the data of the malfeasant event or the potential malfeasant event; generate a primary dynamic constraint specification template (e.g., a flexible template, database, and/or data aggregator) comprising a base set of parameters, wherein the base set of parameters are based on the parsed data of the malfeasant event or the potential malfeasant event; identify at least one secondary malfeasant event or at least one secondary potential malfeasant event (e.g., occurring after the malfeasant event and/or potential malfeasant event of the primary dynamic constraint specification template), wherein the at least one secondary malfeasant event or the at least one secondary potential malfeasant event comprises secondary data; parse the secondary data of the least one secondary malfeasant event or the at least one secondary potential malfeasant event; and generate at least one secondary dynamic constraint specification template comprising a secondary set of parameters, wherein the secondary set of parameters are based on the parsed secondary data, and wherein the at least one secondary dynamic constraint specification template is a modification of the primary dynamic constraint specification template.

What is more, the present disclosure provides a technical solution to a technical problem. As described herein, the technical problem includes the difficulty in identifying and managing vulnerabilities in complex and dynamic computing environments, which often results in delayed responses to potential vulnerabilities, leading to security breaches, financial losses, and operational disruption.

The technical solution presented herein allows for the use of a dynamic, AI/ML-based system that continuously adapts to changing landscapes and optimizes its performance based on real-world experiences and emerging trends. This system employs a Constraint Specification Matrix, a tool that combines human expertise and domain-specific knowledge with machine learning capabilities to accurately identify vulnerability vectors and predict potential system vulnerabilities. In particular, this AI/ML-based system is an improvement over existing solutions to the problem of vulnerability detection and management. It accomplishes this (i) with fewer steps to achieve the solution, thus reducing the amount of computing resources, such as processing resources, storage resources, network resources, and/or the like, that are being used (e.g., by replacing dynamic constraint specification templates with up-to-date and most recent dynamic constraint specification template, storage and computing capabilities may be improved); (ii) providing a more accurate solution to the problem, thus reducing the number of resources required to remedy any errors made due to a less accurate solution (e.g., through the use of both ML models and AI models, more accurate determinations of patterns within the data of events may be identified and used to determine brand new cybersecurity threats); (iii) removing manual input and waste from the implementation of the solution, thus improving speed and efficiency of the process and conserving computing resources; (iv) determining an optimal amount of resources that need to be used to implement the solution, thus reducing network traffic and load on existing computing resources (e.g., by only storing those dynamic constraint specification templates necessary to make the cybersecurity threat determinations less resources are used for both storage, searching, and recall).

Furthermore, the technical solution described herein uses a rigorous, computerized process to perform specific tasks and/or activities that were not previously performed. In specific implementations, the technical solution bypasses a series of steps previously implemented, thus further conserving computing resources. The introduction of the dynamic Constraint Specification Matrix as an adaptable tool in the workflow represents a significant leap forward, as it streamlines the process of vulnerability detection and enables a more proactive and precise approach to cybersecurity management.

The use of a AI/ML-based system that continuously adapts to changing landscapes and optimizes its performance based on real-world experiences and emerging trends in order to verify network security allows the system described herein to generate multiple dynamic constraint specification templates based on newly identified trends in cybersecurity and other such electronic malfeasant activities. Thus, the system may act by generating new dynamic constraint specification templates whenever a new type of electronic malfeasant activity is identified (even where a prior rule may not have picked up on the prior malfeasant activity), but may also keep and/or store an original dynamic constraint specification template to keep for a reference at all times. Thus, the system as described herein represents an improvement over conventional security protocols, by only storing those dynamic constraint specification templates which are on trend with current cybersecurity threats, and by determining and identifying patterns of data and parameters of these cybersecurity threats where previously such patterns may have never been identified, and by generating alerts (such as vulnerability vector change interface components) to identify to an entity when a cybersecurity threat has been identified and where the network vulnerabilities are located, thereby yielding a tangible technological benefit. Specifically, the claimed system is less vulnerable to hacking or other similar security threats than conventional systems.

Additionally, the receipt, correlation, and enhancement of data via the dynamic Constraint Specification Matrix as an adaptable tool in the workflow as described herein enables load distribution by allowing data to be stored at individual data sources in a distributed manner. Previous systems require that all applicable information is hosted at one central location, which requires massive databases and increases network traffic as data continuously flows from each data source to the central server. In contrast, the distributed storage described herein reduces network congestion with its ability to monitor data from multiple different channels, while still allowing the data to be accessible as needed to achieve the features and functions of the system. One of ordinary skill in the art will appreciate that the system utilizes actual data of the system as it is monitored, rather than relying on additionally generated data metrics or metadata, which results in an efficient approach reducing the load on the entity system as compared to conventional solutions.

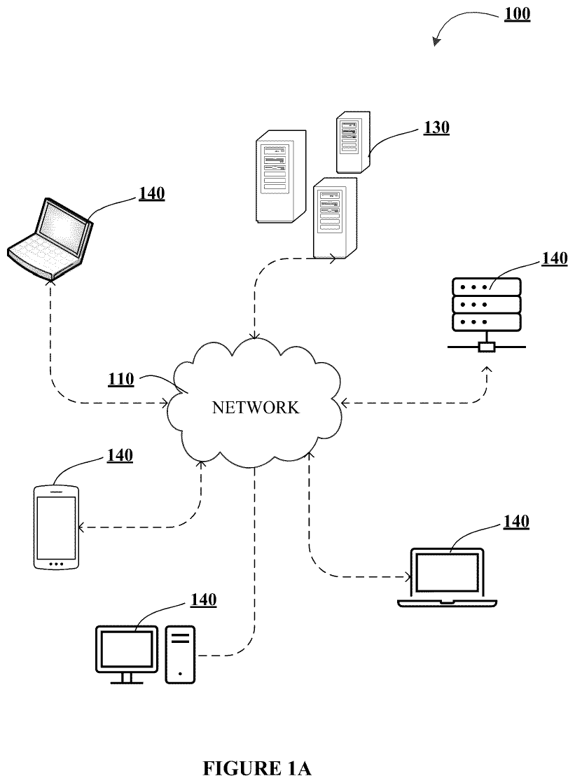

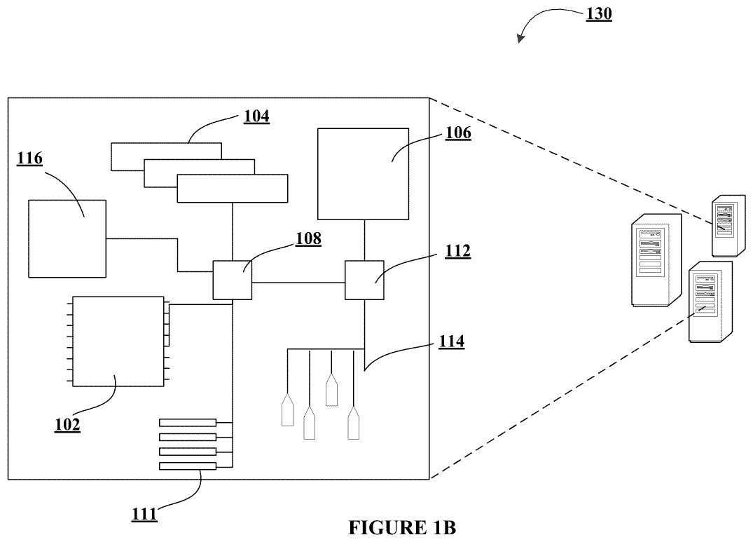

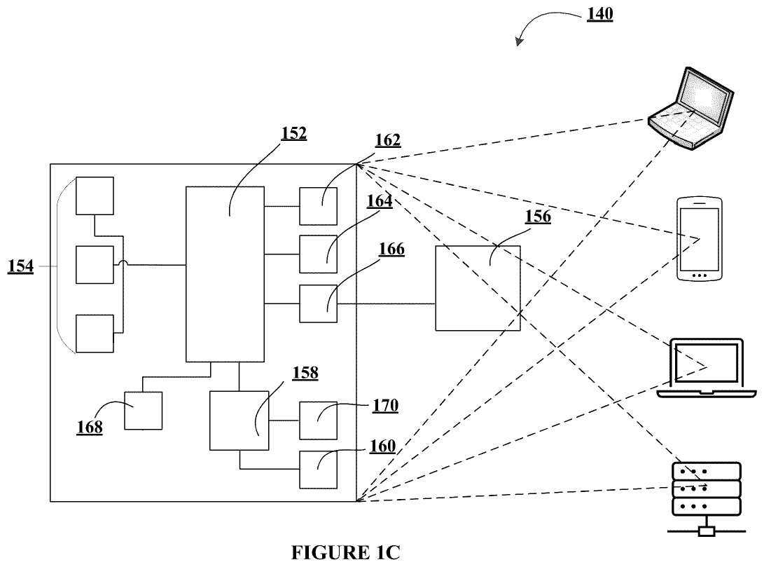

FIGS. 1A-1C illustrate technical components of an exemplary distributed computing environment for detecting cybersecurity events using centralized data aggregation and dynamic constraint specification templates in an electronic environment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

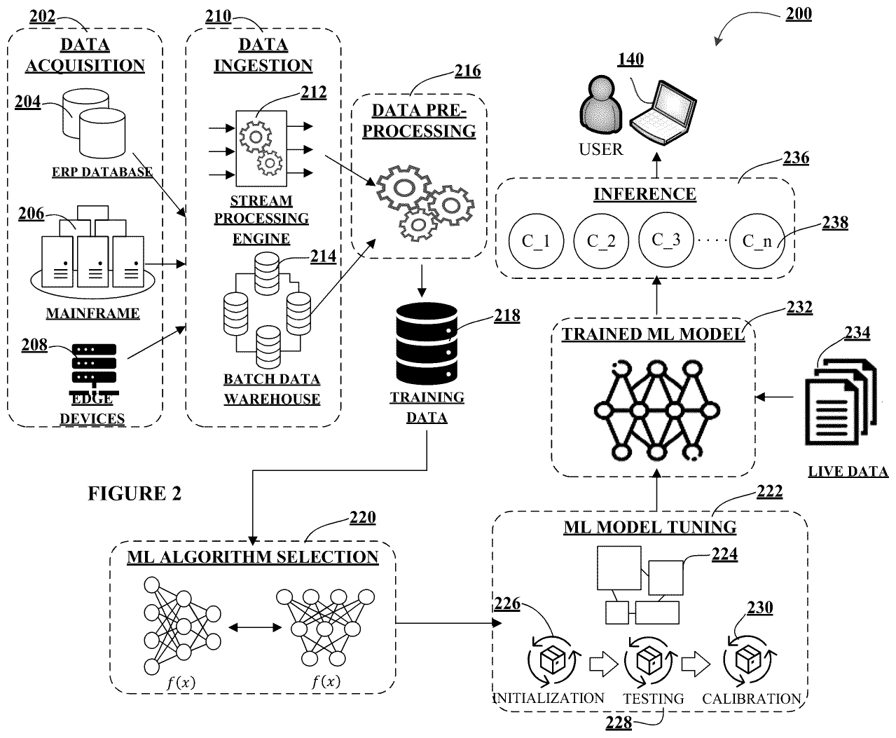

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

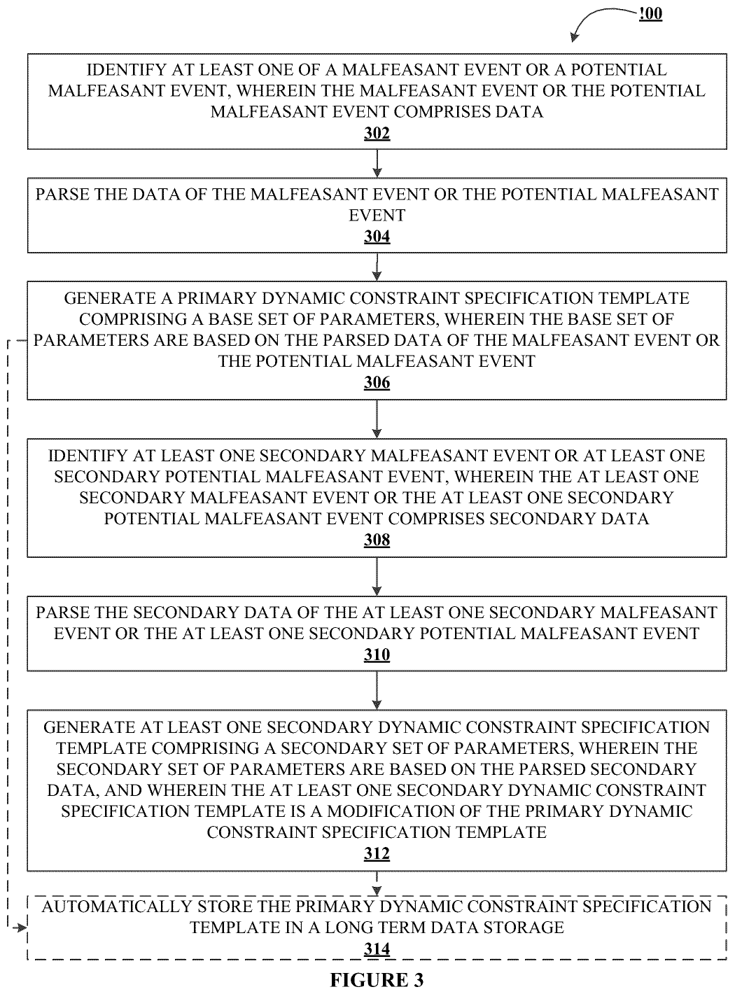

FIG. 3 illustrates a process flow for detecting cybersecurity events using centralized data aggregation and dynamic constraint specification templates in an electronic environment, in accordance with an embodiment of the disclosure. In some embodiments, a system (e.g., similar to one or more of the systems described herein with respect to FIGS. 1A-1C and 2) may perform one or more of the steps of process flow 300. For example, a system (e.g., the system 130 described herein with respect to FIG. 1A-1C) may perform the steps of process flow 300.

As shown in block 302, the process flow 300 may include the step of identifying at least one of a malfeasant event or a potential malfeasant event, wherein the malfeasant event or the potential malfeasant event comprises data. As used herein, a malfeasant event refers to an identified malfeasant action, such as but not limited to an action from a bad actor; an action that has not been authorized by an authenticated user (such as where the action comprises accessing a user account within prior authorization); an action comprising a request for resources under false pretenses; a cybersecurity breach; and/or the like. Additionally, a potential malfeasant event as referred to herein describes a not-yet identified malfeasant event or malfeasant action, but an event or action that may potentially be identified as a malfeasant event or malfeasant action at a future time (e.g., based on analyzing the data of the potential malfeasant event). In some embodiments, the system may additionally and/or alternatively gather and identify data associated with a non-malfeasant event or non-malfeasant action (i.e., an event or action that has been identified as being non-malfeasant), whereby such associated data may be used by the system as a comparison against the malfeasant event data and potential malfeasant event data (such as a baseline set of data). In some embodiments, the system may additionally generate a dynamic constraint specification template(s), vulnerability vectors (described in further detail hereinbelow), and/or the like based on the non-malfeasant event data, and may use such generated dynamic constraint specification template(s), vulnerability vectors, and/or the like to compare against the malfeasant event and potential malfeasant event dynamic constraint specification template(s) and associated vulnerability vector(s) in much the same way as described below to determine malfeasant event patterns and identify future malfeasant events.

As used herein, an “event” such as that used in “malfeasant event,” “potential malfeasant event,” and (in some circumstances) and identified “non-malfeasant event” may comprise at least one of an authentication input event (such as inputting a username and/or password and other such authentication credentials); submitting a resource transmission request, submitting an API request or API call; accessing a network; geographical data regarding such accessing a network, submitting a request, inputting authentication credentials, and/or the like; resource access requests; indicator of compromise (IoC) data (e.g., clues and evidence of a cybersecurity data breach); clicks and other such computing inputs; and/or the like.

As described herein, and in either instance of an identified malfeasant event and/or a potential malfeasant event, the system may collect data both used to normally identify an event as a malfeasant event (e.g., based on pre-determined rules, such as rules comprising definitions of what data is a normal indicator of a malfeasant event, which may be based on historical knowledge of past malfeasant events) and the data that is not normally used to identify a malfeasant event (e.g., peripheral data that is not normally considered in identifying malfeasant events) and where the system may additionally collect and parse such peripheral data in order to identify underlying patterns that normally would not be recognized or seen otherwise. In some embodiments, such data (e.g., peripheral data) may comprise data collected regarding inputs received, transactions identified, geolocations identified (e.g., geolocation identifiers); party identifiers (e.g., recipient identifiers and/or sender identifiers); access data (such as data regarding access attempts to a network, an application, and/or the like, such as authentication credentials input, clicks received, and/or the like); and/or the like. In some such embodiments, some the peripheral data collected comprise IP addresses; amounts of resources; party identifiers (e.g., parties within a transaction, such as a resource transaction); telemetry data; and other such data not normally collected and/or analyzed.

As shown in block 304, the process flow 300 may include the step of parsing the data of the malfeasant event or the potential malfeasant event. For instance, the system may parse the data of the malfeasant event(s), the potential malfeasant event(s), and in some embodiments the non-malfeasant event(s), and/or the like. For instance, the system may parse and/or break up the data of the malfeasant event(s), the potential malfeasant event(s), and/or the non-malfeasant event(s) such that each piece of data may be organized (such as within a database or the dynamic constraint specification template), analyzed separately, and analyzed together.

As shown in block 306, the process flow 300 may include the step of generating a primary dynamic constraint specification template comprising a base set of parameters, wherein the base set of parameters are based on the parsed data of the malfeasant event or the potential malfeasant event. For example, the system may generate a primary dynamic constraint specification template based on the parsed data of the malfeasant event and/or the potential malfeasant event. As used herein the malfeasant event and/or potential malfeasant event (and/or non-malfeasant event) may be used as a primary indicator of a malfeasant action-including its associated data-which may be used as a baseline for future potential malfeasant events and their associated data. In this manner, the primary dynamic constraint specification template may act as a standard reference for future malfeasant event determinations, such that the primary dynamic constraint specification template comprises a first set of malfeasant event data, non-malfeasant event data, and potential malfeasant event data, where patterns and vulnerability vectors may be generated from.

As used herein, the primary dynamic constraint specification template may be configured to comprise a flexible database and/or central data aggregator of the parsed data of the malfeasant events, potential malfeasant events, and/or the like. The flexible database and/or central data aggregator may comprise the parsed data in a particularized format (e.g., rows, columns, and/or the like to analyze the data both separately and together in certain formations or algorithms), such that patterns between the data and the determination of whether the event is malfeasant or not may be determined. In some embodiments, the primary dynamic constraint specification template may additionally and/or alternatively comprise rules and/or the like used to determine which events are likely malfeasant events (e.g., where an event comprises the presence of four particular datapoints, then the rule may require the same datapoints presences to determine the event is a malfeasant event).

In some embodiments, the malfeasant event data, potential malfeasant event data, and/or non-malfeasant event data used for the primary dynamic constraint specification template may be used to generate a base set of parameters for the primary dynamic constraint specification template. Such a base set of parameters may comprise data which may be used for comparison against for future determinations of malfeasant events and/or non-malfeasant events. For instance, the base set of parameters may be first sighting of data/parameters for a malfeasant event (e.g., may be the first instance we're seeing a particular party identifier, may be first time we're seeing a particular malfeasant activity or potential malfeasant activity and associated data, and/or the like) and/or the base set of parameters may comprise a baseline of data for a non-malfeasant event, such as a normal behavior and/or normal electronic data.

As shown in block 308, the process flow 300 may include the step of identifying at least one secondary malfeasant event or at least one secondary potential malfeasant event, wherein the at least one secondary malfeasant event or the at least one secondary potential malfeasant event comprises secondary data. For instance, and as more events and actions are identified (such as more actions and events associated with an entity, such as a company, a financial institution, and/or the like), the system may additionally identify these future and/or current events and activities (and their associated data) as a secondary malfeasant event, secondary potential malfeasant event, and/or secondary non-malfeasant event. In some embodiments, the at least one secondary malfeasant event, potential malfeasant event, and/or non-malfeasant event may comprise a plurality of secondary malfeasant events, a plurality of secondary potential malfeasant events, a plurality of secondary non-malfeasant events, and/or a combination thereof. Additionally, and by way of non-limiting example, such secondary malfeasant event(s), secondary potential malfeasant event(s), secondary non-malfeasant event(s) may occur and/or be identified after the malfeasant event(s), potential malfeasant event(s), and/or non-malfeasant events of the primary dynamic constraint specification template.

As show in block 310, the process flow 300 may include the step of parsing the secondary data of the at least one secondary malfeasant event or the at least one secondary potential malfeasant event. For instance, the system may parse the secondary data of the secondary malfeasant event(s), secondary potential malfeasant event(s), secondary non-malfeasant event(s) in the same or similar manner as the parsed data of the malfeasant event(s), potential malfeasant event(s), non-malfeasant event(s).

Additionally, and similar to the data of the malfeasant event(s), potential malfeasant event(s), and non-malfeasant event(s) described above, the same and/or similar data may be identified, collected, and parsed by the system for the at least one secondary malfeasant event, the at least one secondary potential malfeasant event, and/or the at least one secondary non-malfeasant event. As understood by a person of skill in the art, each of the pieces of data herein described within this application may additionally be identified, collected, and parsed by the system for any of the malfeasant event(s), potential malfeasant events, and/or non-malfeasant events identified by the system.

As shown in block 312, the process flow 300 may include the step of generating at least one secondary dynamic constraint specification template comprising a secondary set of parameters, wherein the secondary set of parameters are based on the parsed secondary data, and wherein the at least one secondary dynamic constraint specification template is a modification of the primary dynamic constraint specification template. For example, the system may generate at least one secondary (and/or a plurality of secondary) dynamic constraint specification templates comprising at least one secondary of parameters which may be used by the system to generate patterns and vulnerability vectors in order to determine whether a malfeasant event has likely occurred.

As used herein, the at least one secondary dynamic constraint specification template may be a modification of the primary dynamic constraint specification template, such that the secondary dynamic constraint specification template comprises the same and/or similar data and/or the same and/or similar circumstances (e.g., the same and/or similar requests to access data, the same and/or similar network, the same and/or similar entity associated with the access requests, and/or the like). In this manner, the primary dynamic constraint specification template and its parameters may be used as a reference and/or guide for the at least one secondary dynamic constraint specification template(s).

In some embodiments, the primary dynamic constraint specification template and the at least one secondary dynamic constraint specification template may comprise at least one rule for the primary set of parameters or for the secondary set of parameters. For instance, a rule may define the set of parameters (and/or data) that should be present to determine an event is likely malfeasant or not, and each of the primary dynamic constraint specification template and the at least one secondary dynamic constraint specification template(s) may comprise the same rule(s) and/or similar rule(s) (e.g., comprising most of the same parameter requirements and/or used for the same malfeasant activity determination). In some embodiments, these rules may be dynamically changed and/or changed based on inputs received by the system, such as inputs received from a client of the system, a manager of the system, a user of the system, and/or the like. Such a dynamic change to the rules may comprise a dynamic determination by the system (such as by the ML model and/or AI engine used by the system) that a rule should be changed based on new data received and new patterns generated from the new data.

In some embodiments, and as shown in block 314, the process flow 300 may include the step of automatically storing the primary dynamic constraint specification template in a long term data storage. For instance, and in some embodiments, once the primary dynamic constraint specification template has been generated, the system may automatically store the primary dynamic constraint specification template in a long term data storage, such that the primary dynamic constraint specification template is kept in its original form while new secondary dynamic constraint specification template(s) are generated and analyzed. In this manner, the system may save the primary dynamic constraint specification template in its original format and dynamically generate new formats and/or versions as the system deems it necessary, while the original format of the primary dynamic constraint specification template may continue to be used by the system as a standard reference.

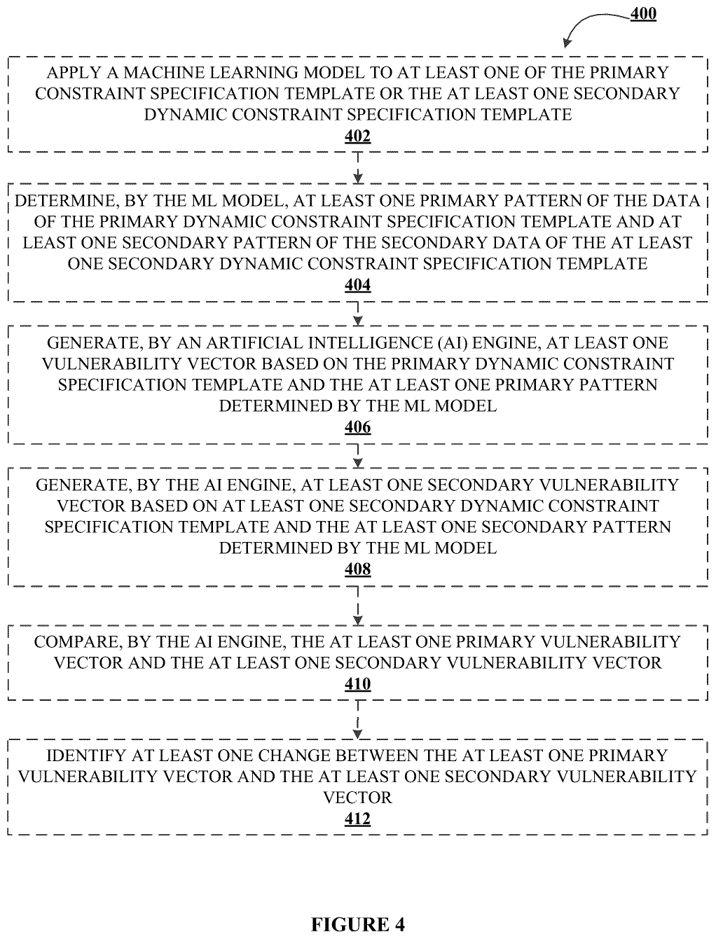

FIG. 4 illustrates a process flow for identifying at least one change between the primary vulnerability vector and the at least one secondary vulnerability vector, in accordance with an embodiment of the disclosure. In some embodiments, a system (e.g., similar to one or more of the systems described herein with respect to FIGS. 1A-1C and 2) may perform one or more of the steps of process flow 400. For example, a system (e.g., the system 130 described herein with respect to FIG. 1A-1C) may perform the steps of process flow 400.

In some embodiments, and as shown in block 402, the process flow 400 may include the step of applying a machine learning (ML) model to at least one of the primary dynamic constraint specification template or the at least one secondary dynamic constraint specification template. For example, the system may apply a trained ML model to the primary dynamic constraint specification template (and/or a plurality of primary dynamic constraint specification templates, such as where a client and/or entity of the system has multiple primary dynamic constraint specification templates) in order identify any patterns that may be present within the parameters of the primary dynamic constraint specification template. Additionally, the trained ML model may be applied to the at least one secondary dynamic constraint specification template in order to identify any patterns that may be present within the parameters of the at least one secondary dynamic constraint specification template (which may be the same, similar to, and/or different than the patterns identified in the primary dynamic constraint specification template). In some embodiments, the system—via the trained ML model—may only identify one pattern for the primary dynamic constraint specification template and/or the at least one secondary dynamic constraint specification template. Such a training of the ML model to generate a trained ML model is discussed in detail below.

The machine learning model herein described may be trained by collecting a first set of data from at least one of a malfeasant event(s) (e.g., a previously identified malfeasant event, which may be pre-tagged as a malfeasant event) and/or a non-malfeasant event(s) (e.g., a previously identified non-malfeasant event, which may be pre-tagged as a non-malfeasant event). In some embodiments, the data from the at least one of the malfeasant event(s) and/or the non-malfeasant event(s) may comprise only the data needed to determine whether it is a malfeasant event or not (e.g., based on a pre-defined rule(s)) or the data may additionally comprise all the data collected and identified by the system (such as peripheral data not needed as defined by the rule(s)). Thus, and based on the collection of the data, the system may generate at least one first training dataset comprising the data collected and apply the at least one first training dataset to the ML model to train the ML model. Thus, and in this manner, the ML model may be trained to look not only for the data/parameters associated with the rules, but also the data/parameters not usually considered by the rules, where such looking beyond the data/parameters of the rules will allow the ML model to be trained to identify additional patterns that would otherwise be overlooked.

In some embodiments, the system may continuously refine the ML model using a plurality of training datasets, where each training dataset comprises newly identified and collected data from identified malfeasant events and/or identified non-malfeasant events.

In some embodiments, and as shown in block 404, the process flow 400 may include the step of determining—by the ML model—at least one primary pattern of the data of the primary dynamic constraint specification template and at least one secondary pattern of the secondary data of the at least one secondary dynamic constraint specification template. For instance, the system may determine—using the ML model—at least one primary pattern of the data/parameters of the primary dynamic constraint specification template and at least one secondary pattern of the at least one secondary dynamic constraint specification template(s), whereby such patterns may be the same, similar, and/or different from each other.

In some embodiments, and as shown in block 406, the process flow 400 may include the step of generating—by an artificial intelligence (AI) engine—at least one vulnerability vector based on the primary dynamic constraint specification template and the at least one primary pattern determined by the ML model. For example, the system may generate—by an AI engine—and based on the identified patterns of the primary dynamic constraint specification template and the at least one secondary dynamic constraint specification template at least one vulnerability vector for each of the identified patterns. Such a vulnerability vector, as used herein, may refer to a one-dimensional array identifying potential vulnerabilities, such as cybersecurity vulnerabilities, user account vulnerabilities, resource account vulnerabilities, and/or the like. In some embodiments, the vulnerability vector(s) may indicate data points and/or parameters used to determine the event is a malfeasant event, which may be used by the system to identify points of vulnerability within the client's system environment that should be addressed and/or protected.

In some embodiments, and as shown in block 408, the process flow 400 may include the step of generating—by the AI engine—at least one secondary vulnerability vector based on at least one secondary dynamic constraint specification template and the at least one secondary pattern determined by the ML model. For instance, the system may generate—by the AI engine—at least one secondary vulnerability vector based on the at least one secondary dynamic constraint specification template and its associated identified pattern(s). In a similar manner and/or the same manner as the process described above with respect to the vulnerability vector(s) of the primary dynamic constraint specification template, the system may additionally—via the AI engine—generate at least one vulnerability vector for the at least one secondary dynamic constraint specification template. Thus, and in some embodiments, for each pattern identified by the ML model, a vulnerability vector may be generated by the AI engine.

In some embodiments, and as shown in block 410, the process flow 400 may include the step of comparing—by the AI engine—the at least one primary vulnerability vector and the at least one secondary vulnerability vector. For instance, and after the vulnerability vector(s) for the primary dynamic constraint specification template and the at least one secondary dynamic constraint specification template have been generated, the system may compare—via the AI engine—the vulnerability vectors to determine whether any changes and/or differences are present between the vulnerability vectors. Such changes and/or differences may indicate new vulnerabilities for the computing system, network, and accounts that were not previously identified or that a client was not previously aware of. Thus, and as shown herein, the difference(s) between the vulnerability vectors of the primary dynamic constraint specification template and the at least one secondary dynamic constraint specification template(s) may be indicative of new methods used by bad actors in attempting to misappropriate data, resources, and/or accounts, and/or conduct cybersecurity threats, and/or the like.

In some embodiments, and as shown in block 412, the process flow 400 may include the step of identifying at least one change between the at least one primary vulnerability vector and the at least one secondary vulnerability vector. For example, the system may identify at least one change between the primary vulnerability vector(s) (i.e., the vulnerability vector(s) of the primary dynamic constraint specification template) and the at least one secondary vulnerability vector(s) (i.e., the vulnerability vector(s) of at least one secondary dynamic constraint specification template). In some embodiments, the vulnerability vector(s) compared between the dynamic constraint specification templates may comprise the exact same parameters, some of the same parameters, and/or completely different parameters. The system, in some embodiments, may determine which vulnerability vector(s) to compare between the dynamic constraint specification templates based on the type of cybersecurity threat, based on the type of access requested, based on a user account identifier, based on a recipient account identifier, based on the geographic location data, and/or based on other such similar data, whereby only one similarity in data may be necessary for comparison.

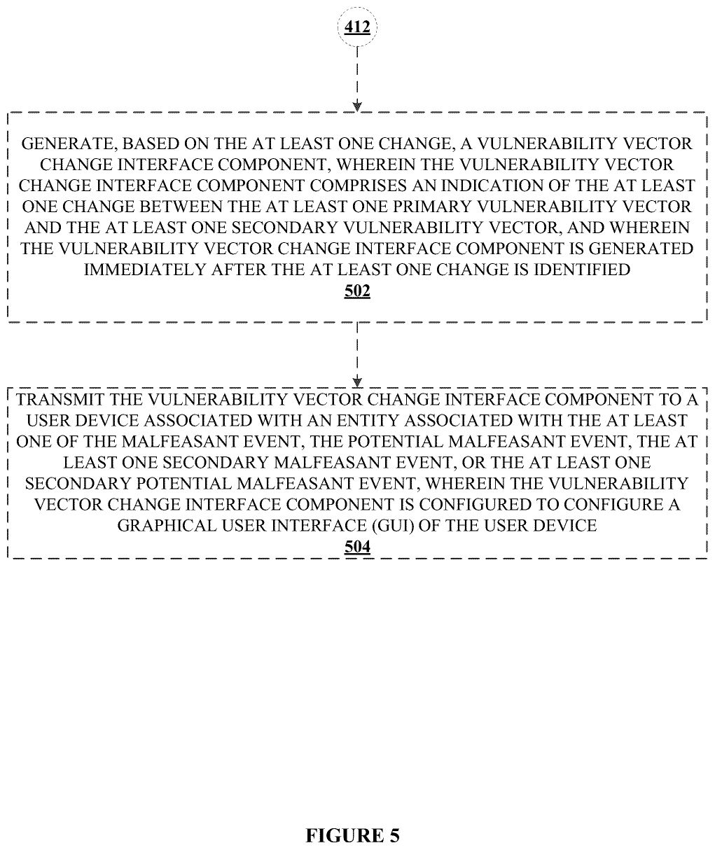

FIG. 5 illustrates a process flow for transmitting a vulnerability vector change interface component to a user device for configuration on graphical user interface (GUI), in accordance with an embodiment of the disclosure. In some embodiments, a system (e.g., similar to one or more of the systems described herein with respect to FIGS. 1A-1C and 2) may perform one or more of the steps of process flow 500. For example, a system (e.g., the system 130 described herein with respect to FIG. 1A-1C) may perform the steps of process flow 500.

In some embodiments, and as shown in block 502, the process flow 500 may include the step of generating—based on the at least one change—a vulnerability vector change interface component, wherein the vulnerability vector change interface component comprises an indication of the at least one change between the at least one primary vulnerability vector and the at least one secondary vulnerability vector, and wherein the vulnerability vector change interface component is generated immediately after the at least one change is identified. For example, the system may generate—based on identifying at least one change (e.g., such as that described above with respect to block 412 of FIG. 4)—a vulnerability vector change between the primary vulnerability vector and at least one secondary vulnerability vector. Based on the vulnerability vector change identified, the system may then generate a vulnerability vector change interface component, which comprises data regarding the vulnerability vector change in a machine readable format, and which further comprises data to configure a graphical user interface (GUI) of a user device to show the data of the vulnerability vector change (e.g., what vulnerability(ies) are present in a client's system, in the client's network, for access accounts, for resource accounts, and/or the like). Such a vulnerability vector change interface component may thus comprise the packet of data regarding the vulnerability vector change that may be transmitted over a network (such as network 110 of FIG. 1A) to a user device (e.g., user device 140 of FIG. 1A, and/or the like).

Further, and additionally, the vulnerability vector change interface component may be automatically and immediately generated after the vulnerability vector change is determined. In this manner, the vulnerability vector change interface component may act as an alert to automatically configure a GUI on a user device with the potential vulnerability (ies) that a client should be made aware of immediately.

In some embodiments, and as shown in block 504, the process flow 500 may include the step of transmitting the vulnerability vector change interface component to a user device associated with an entity associated with the at least one of the malfeasant event, the potential malfeasant event, the at least one secondary malfeasant event, and/or the at least one secondary potential malfeasant event, wherein the vulnerability vector change interface component is configured to configure a graphical user interface (GUI) of the user device. For example, the system may transmit the vulnerability vector change interface component to a user device, such as a user device associated with a client of the system (e.g., a financial institution, a company, and/or the like), whereby the user device may further be associated with at least one of the parameters or data identified as being a part of a malfeasance event. For instance, and where the malfeasance event is associated with a request for accessing a user account, the user device which receives the vulnerability vector change interface component may be associated with the entity that owns and/or operates the user account on their server(s).

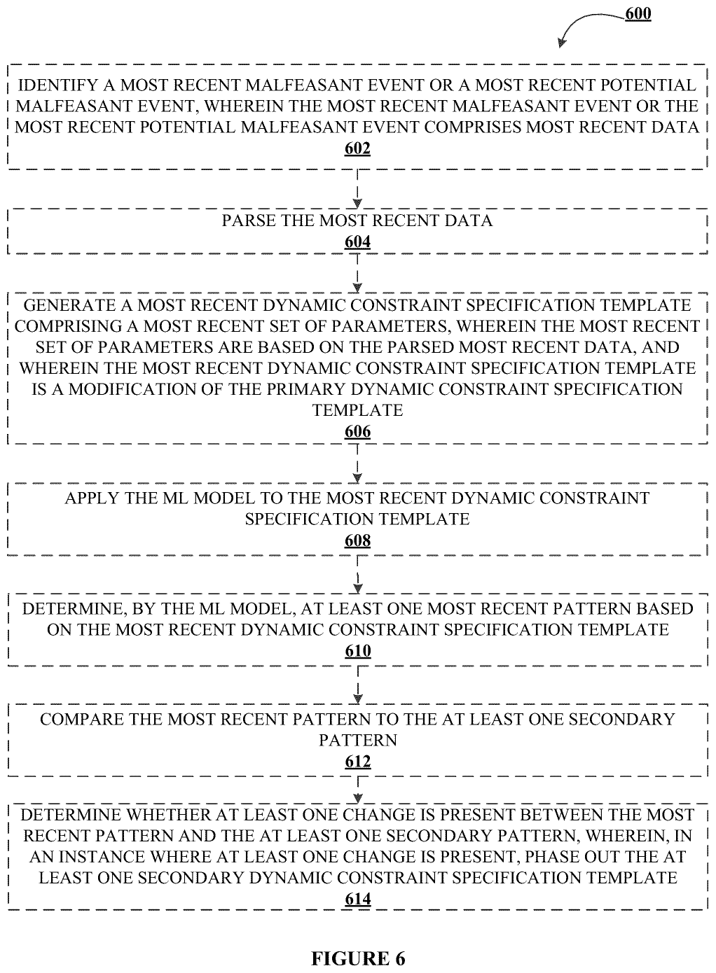

FIG. 6 illustrates a process flow for determining whether at least one change is present between a most recent pattern and at least one secondary pattern, in accordance with an embodiment of the disclosure. In some embodiments, a system (e.g., similar to one or more of the systems described herein with respect to FIGS. 1A-1C and 2) may perform one or more of the steps of process flow 600. For example, a system (e.g., the system 130 described herein with respect to FIG. 1A-1C) may perform the steps of process flow 600.

In some embodiments, and as shown in block 602, the process flow 600 may include the step of identifying a most recent malfeasant event or a most recent potential malfeasant event, wherein the most recent malfeasant event or the most recent potential malfeasant event comprises most recent data. As used herein the term “most recent” (as used within “a most recent malfeasant event,” “a most recent potential malfeasant event,” and/or “a most recent non-malfeasant event”) describes an event that has most recently been identified by the system as occurring (e.g., the most recent in time to the current time), whereby such an action or event was not previously identified by the system as having occurred. Further, the system may additionally identify the data associated with the most recent malfeasant event, the most recent potential event, and—in some embodiments—the most recent non-malfeasant event.

In some embodiments, and as shown in block 604, the process flow 600 may include the step of parsing the most recent data. Thus, and as described briefly above, the system may first identify the data associated with the most recent event(s) (e.g., the most recent malfeasant event, the most recent potential event, and/or the most recent non-malfeasant event) and then may parse the most recent data to determine patterns from the most recent data, similar to the process describe above with respect to the malfeasant event, non-malfeasant event, at least one secondary malfeasant event, at least one potential malfeasant event, and/or the like.

In some embodiments, and as shown in block 606, the process flow 600 may include the step of generating a most recent dynamic constraint specification template comprising a most recent set of parameters, wherein the most recent set of parameters are based on the parsed most recent data, and wherein the most recent dynamic constraint specification template is a modification of the primary dynamic constraint specification template. For example, the system may additionally generate a most recent dynamic constraint specification template based on the most recent set of parameters (which are based on the most recent data that was parsed), whereby the most recent dynamic constraint specification template is generated in the same manner as the primary dynamic constraint specification template.

Further, and similar to the at least one second dynamic constraint specification template, the most recent dynamic constraint specification template may additionally be a modification of the primary dynamic constraint specification template. In this manner, the most recent dynamic constraint specification template may comprise similar and/or the same rules, parameters, and/or the like to both and/or only one of the primary dynamic constraint specification template and/or the at least one secondary dynamic constraint specification template.

In some embodiments, the most recent dynamic constraint specification template may also be a modification of the at least one secondary dynamic constraint specification template and/or the previous most recent dynamic constraint specification template (such as the most recent at least one secondary dynamic constraint specification template that was most recently generated). Thus, and as shown herein, the at least one secondary dynamic constraint specification template is generated at time previous to the most recent dynamic constraint specification template and at a time after to the primary dynamic constraint specification template. In this manner, the most recent dynamic constraint specification template may be used to show the most recent and up-to-date patterns of malfeasant actors and how they may have changed since the last most-recent dynamic constraint specification template (i.e., the most recent of the at least one secondary dynamic constraint specification template(s)).

In some embodiments, and as shown in block 608, the process flow 600 may include the step of applying the ML model to the most recent dynamic constraint specification template. In some embodiments, and as shown in block 610, the process flow 600 may include the step of determining—by the ML model—at least one most recent pattern based on the most recent dynamic constraint specification template. For instance, the system may apply the same trained ML model as applied to the primary dynamic constraint specification template and the at least one secondary dynamic constraint specification template to the most recent dynamic constraint specification template in order to determine at least one pattern of the most recent dynamic constraint specification template, including those patterns that previously may not have been identified based on normal rules.

In some embodiments, and as shown in block 612, the process flow 600 may include the step of comparing the most recent pattern to the at least one secondary pattern. Thus, and based on the determination of the most recent pattern(s) by the ML model, the system may compare the most recent pattern(s) to the at least one secondary pattern(s), whereby the at least one secondary pattern(s) is associated with the most recent of the at least one secondary dynamic constraint specification template (i.e., most recent prior to the current most recent malfeasant event and/or most recent potential malfeasant event). In this manner, the system can determine the most recent changes to have occurred between the patterns most recently determined, which will also the system to determine what bad actors are doing at a current time as compared to at least one previous time that was directly before the current time.

In some embodiments, and as shown in block 614, the process flow 600 may include the step of determining whether at least one change is present between the most recent pattern and the at least one secondary pattern, wherein—in an instance where at least one change is present-replace the at least one secondary dynamic constraint specification template. For example, the system may determine and/or identify at least one change between the most recent pattern (i.e., from the most recent dynamic constraint specification template) as compared to the previous most recent of the at least one secondary dynamic constraint specification template, and based on this identification of at least one change, the system may replace the previous most recent of the at least on secondary dynamic constraint specification template. In this manner, the system may store at least the primary dynamic constraint specification template and the most recent dynamic constraint specification template in its data storage rather than storing each and every modification and/or iteration of the primary dynamic constraint specification template. Such a feature allows for less storage requirements by the system, greater processing speeds, and allows for automatic phasing out of obsolete dynamic constraint specification template(s) which may no longer be necessary for identifying malfeasant activities. However, and in some embodiments—and in order to compare the most recent pattern(s) against the most recent of the at least one secondary patterns—the system may additionally store the most recent of the at least one secondary dynamic constraint specification templates.

However, and in the instance where no changes are present between the most recent pattern(s) and the most recent of the at least one secondary pattern(s), the system may not replace the most recent of the at least one secondary dynamic constraint specification template. Thus, the system may continue to store the most recent of the at least one secondary dynamic constraint specification templates. In some embodiments, the system may additionally store the most recent dynamic constraint specification template along with the most recent of the at least one secondary dynamic constraint specification templates for comparison to a future most recent dynamic constraint specification template.

As used herein, the term “replace” or “replacing” refers to an instance in which a dynamic constraint specification template is replaced (and/or saved over) with another dynamic constraint specification template for data processing. In some embodiments, the replacing of a dynamic constraint specification template may comprise a storage of the replaced dynamic constraint specification template, a deletion of the replaced dynamic constraint specification template, an updating of a dynamic constraint specification template (e.g., an update the most recent of the at least one secondary dynamic constraint specification templates with the data and patterns of the most recent dynamic constraint specification template) and/or the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for detecting cybersecurity events using centralized data aggregation and dynamic constraint specification templates in an electronic environment, the system comprising:
a memory device with computer-readable program code stored thereon;
at least one processing device, wherein executing the computer-readable code is configured to cause the at least one processing device to perform the following operations:
identify at least one of a malfeasant event or a potential malfeasant event, wherein the malfeasant event or the potential malfeasant event comprises data;
parse the data of the malfeasant event or the potential malfeasant event;
generate a primary dynamic constraint specification template comprising a base set of parameters, wherein the base set of parameters are based on the parsed data of the malfeasant event or the potential malfeasant event;
identify at least one secondary malfeasant event or at least one secondary potential malfeasant event, wherein the at least one secondary malfeasant event or the at least one secondary potential malfeasant event comprises secondary data;
parse the secondary data of the least one secondary malfeasant event or the at least one secondary potential malfeasant event; and
generate at least one secondary dynamic constraint specification template comprising a secondary set of parameters, wherein the secondary set of parameters are based on the parsed secondary data, and wherein the at least one secondary dynamic constraint specification template is a modification of the primary dynamic constraint specification template.

2. The system of claim 1, the system further comprising:
automatically store the primary dynamic constraint specification template in a long term data storage.

3. The system of claim 1, the system further comprising:
apply a machine learning (ML) model to at least one of the primary dynamic constraint specification template or the at least one secondary dynamic constraint specification template; and
determine, by the ML model, at least one primary pattern of the data of the primary dynamic constraint specification template and at least one secondary pattern of the secondary data of the at least one secondary dynamic constraint specification template.

4. The system of claim 3, the system further comprising:
generate, by an artificial intelligence (AI) engine, at least one vulnerability vector based on the primary dynamic constraint specification template and the at least one primary pattern determined by the ML model;
generate, by the AI engine, at least one secondary vulnerability vector based on at least one secondary dynamic constraint specification template and the at least one secondary pattern determined by the ML model; and
compare, by the AI engine, the at least one primary vulnerability vector and the at least one secondary vulnerability vector; and
identify at least one change between the at least one primary vulnerability vector and the at least one secondary vulnerability vector.

5. The system of claim 4, the system further comprising:
generate, based on the at least one change, a vulnerability vector change interface component, wherein the vulnerability vector change interface component comprises an indication of the at least one change between the at least one primary vulnerability vector and the at least one secondary vulnerability vector, and wherein the vulnerability vector change interface component is generated immediately after the at least one change is identified; and
transmit the vulnerability vector change interface component to a user device associated with an entity associated with the at least one of the malfeasant event, the potential malfeasant event, the at least one secondary malfeasant event, or the at least one secondary potential malfeasant event, wherein the vulnerability vector change interface component is configured to configure a graphical user interface (GUI) of the user device.

6. The system of claim 3, the system further comprising:
identify a most recent malfeasant event or a most recent potential malfeasant event, wherein the most recent malfeasant event or the most recent potential malfeasant event comprises most recent data;
parse the most recent data;
generate a most recent dynamic constraint specification template comprising a most recent set of parameters, wherein the most recent set of parameters are based on the parsed most recent data, and wherein the most recent dynamic constraint specification template is a modification of the primary dynamic constraint specification template;
apply the ML model to the most recent dynamic constraint specification template;
determine, by the ML model, at least one most recent pattern based on the most recent dynamic constraint specification template;
compare the most recent pattern to the at least one secondary pattern; and
determine whether at least one change is present between the most recent pattern and the at least one secondary pattern,
wherein, in an instance where at least one change is present, replace the at least one secondary dynamic constraint specification template with the most recent dynamic constraint specification template.

7. The system of claim 6, wherein the at least one secondary dynamic constraint specification template is generated at time previous to the most recent dynamic constraint specification template and at a time after to the primary dynamic constraint specification template.

8. The system of claim 1, wherein the primary dynamic constraint specification template and the at least one secondary dynamic specification template comprise at least one rule for the primary set of parameters or for the secondary set of parameters.

9. The system of claim 1, wherein the primary set of parameters and the at least one secondary set of parameters comprise telemetry data.

10. The system of claim 1, wherein the data of at least one malfeasant event, the at least one potential malfeasant event, the at least one secondary malfeasant event, or at least one secondary potential malfeasant event comprise at least one of an indicator of compromise (IoC) data, account access data, authentication credential data, geographic data, transaction data, or transaction party data.

11. A computer program product for detecting cybersecurity events using centralized data aggregation and dynamic constraint specification templates in an electronic environment, wherein the computer program product comprises at least one non-transitory computer-readable medium having computer-readable program code portions embodied therein, the computer-readable program code portions which when executed by a processing device are configured to cause the processor to perform the following operations:
identify at least one of a malfeasant event or a potential malfeasant event, wherein the malfeasant event or the potential malfeasant event comprises data;
parse the data of the malfeasant event or the potential malfeasant event;
generate a primary dynamic constraint specification template comprising a base set of parameters, wherein the base set of parameters are based on the parsed data of the malfeasant event or the potential malfeasant event;
identify at least one secondary malfeasant event or at least one secondary potential malfeasant event, wherein the at least one secondary malfeasant event or the at least one secondary potential malfeasant event comprises secondary data;
parse the secondary data of the least one secondary malfeasant event or the at least one secondary potential malfeasant event; and
generate at least one secondary dynamic constraint specification template comprising a secondary set of parameters, wherein the secondary set of parameters are based on the parsed secondary data, and wherein the at least one secondary dynamic constraint specification template is a modification of the primary dynamic constraint specification template.

12. The computer program product of claim 11, wherein the processing device is configured to cause the processor to perform the following operations:
apply a machine learning (ML) model to at least one of the primary dynamic constraint specification template or the at least one secondary dynamic constraint specification template; and
determine, by the ML model, at least one primary pattern of the data of the primary dynamic constraint specification template and at least one secondary pattern of the secondary data of the at least one secondary dynamic constraint specification template.

13. The computer program product of claim 12, wherein the processing device is configured to cause the processor to perform the following operations:
generating, by an artificial intelligence (AI) engine, at least one vulnerability vector based on the primary dynamic constraint specification template and the at least one primary pattern determined by the ML model;
generating, by the AI engine, at least one secondary vulnerability vector based on at least one secondary dynamic constraint specification template and the at least one secondary pattern determined by the ML model; and
comparing, by the AI engine, the at least one primary vulnerability vector and the at least one secondary vulnerability vector; and
identifying at least one change between the at least one primary vulnerability vector and the at least one secondary vulnerability vector.

14. The computer program product of claim 13, wherein the processing device is configured to cause the processor to perform the following operations:
generate, based on the at least the one change, a vulnerability vector change interface component, wherein the vulnerability vector change interface component comprises an indication of the at least one change between the at least one primary vulnerability vector and the at least one secondary vulnerability vector, and wherein the vulnerability vector change interface component is generated immediately after the at least one change is identified; and
transmit the vulnerability vector change interface component to a user device associated with an entity associated with the at least one of the malfeasant event, the potential malfeasant event, the at least one secondary malfeasant event, or the at least one secondary potential malfeasant event, wherein the vulnerability vector change interface component is configured to configure a graphical user interface (GUI) of the user device.

15. The computer program product of claim 12, wherein the processing device is configured to cause the processor to perform the following operations:
identify a most recent malfeasant event or a most recent potential malfeasant event, wherein the most recent malfeasant event or the most recent potential malfeasant event comprises most recent data;
parse the most recent data;
generate a most recent dynamic constraint specification template comprising a most recent set of parameters, wherein the most recent set of parameters are based on the parsed most recent data, and wherein the most recent dynamic constraint specification template is a modification of the primary dynamic constraint specification template;
apply the ML model to the most recent dynamic constraint specification template;
determine, by the ML model, at least one most recent pattern based on the most recent dynamic constraint specification template;
compare the most recent pattern to the at least one secondary pattern; and
determine whether at least one change is present between the most recent pattern and the at least one secondary pattern,
wherein, in an instance where at least one change is present, replace the at least one secondary dynamic constraint specification template with the most recent dynamic constraint specification template.

16. A computer implemented method for detecting cybersecurity events using centralized data aggregation and dynamic constraint specification templates in an electronic environment, the computer implemented method comprising:
identifying at least one of a malfeasant event or a potential malfeasant event, wherein the malfeasant event or the potential malfeasant event comprises data;
parsing the data of the malfeasant event or the potential malfeasant event;
generating a primary dynamic constraint specification template comprising a base set of parameters, wherein the base set of parameters are based on the parsed data of the malfeasant event or the potential malfeasant event;
identifying at least one secondary malfeasant event or at least one secondary potential malfeasant event, wherein the at least one secondary malfeasant event or the at least one secondary potential malfeasant event comprises secondary data;
parsing the secondary data of the least one secondary malfeasant event or the at least one secondary potential malfeasant event; and
generating at least one secondary dynamic constraint specification template comprising a secondary set of parameters, wherein the secondary set of parameters are based on the parsed secondary data, and wherein the at least one secondary dynamic constraint specification template is a modification of the primary dynamic constraint specification template.

17. The computer implemented method of claim 16, the computer implemented method further comprising:
applying a machine learning (ML) model to at least one of the primary dynamic constraint specification template or the at least one secondary dynamic constraint specification template; and
determining, by the ML model, at least one primary pattern of the data of the primary dynamic constraint specification template and at least one secondary pattern of the secondary data of the at least one secondary dynamic constraint specification template.

18. The computer implemented method of claim 17, the computer implemented method further comprising:
generating, by an artificial intelligence (AI) engine, at least one vulnerability vector based on the primary dynamic constraint specification template and the at least one primary pattern determined by the ML model;
generating, by the AI engine, at least one secondary vulnerability vector based on at least one secondary dynamic constraint specification template and the at least one secondary pattern determined by the ML model; and
comparing, by the AI engine, the at least one primary vulnerability vector and the at least one secondary vulnerability vector; and
identifying at least one change between the at least one primary vulnerability vector and the at least one secondary vulnerability vector.

19. The computer implemented method of claim 18, the computer implemented method further comprising:
generating, based on the at least the one change, a vulnerability vector change interface component, wherein the vulnerability vector change interface component comprises an indication of the at least one change between the at least one primary vulnerability vector and the at least one secondary vulnerability vector, and wherein the vulnerability vector change interface component is generated immediately after the at least one change is identified; and
transmitting the vulnerability vector change interface component to a user device associated with an entity associated with the at least one of the malfeasant event, the potential malfeasant event, the at least one secondary malfeasant event, or the at least one secondary potential malfeasant event, wherein the vulnerability vector change interface component is configured to configure a graphical user interface (GUI) of the user device.

20. The computer implemented method of claim 17, the computer implemented method further comprising:
identifying a most recent malfeasant event or a most recent potential malfeasant event, wherein the most recent malfeasant event or the most recent potential malfeasant event comprises most recent data;
parsing the most recent data;
generating a most recent dynamic constraint specification template comprising a most recent set of parameters, wherein the most recent set of parameters are based on the parsed most recent data, and wherein the most recent dynamic constraint specification template is a modification of the primary dynamic constraint specification template;
applying the ML model to the most recent dynamic constraint specification template;
determining, by the ML model, at least one most recent pattern based on the most recent dynamic constraint specification template;
comparing the most recent pattern to the at least one secondary pattern; and
determining whether at least one change is present between the most recent pattern and the at least one secondary pattern,
wherein, in an instance where at least one change is present, replacing the at least one secondary dynamic constraint specification template with the most recent dynamic constraint specification template.
